(19) United States
(12) Patent Application Publication
(10) Pub. No.: US 2024/0313481 A1
(43) Pub. Date: Sep. 19, 2024

(54) Cable Connector Assembly

(71) Applicant: Tyco Electronics Japan G.K., Kawasaki-shi (JP)

(72) Inventor: Kosuke Maeba, Kawasaki-shi (JP)

(73) Assignee: Tyco Electronics Japan G.K., Kawasaki-shi (JP)

(21) Appl. No.: 18/606,062

(22) Filed: Mar. 15, 2024

(30) Foreign Application Priority Data
Mar. 16, 2023 (JP) 2023-042280

(51) Int. Cl. H01R 13/6591; H01R 13/52

(52) U.S. Cl. CPC H01R 13/65917; H01R 13/5205

(57) ABSTRACT

A cable connector assembly includes a connector having a casing and a ring-like member and a cable connected to the connector. The cable has an internal cable and a cable shield surrounding the internal cable. The casing accommodates an end of the cable. The ring-like member is positioned around the cable inside the casing. The ring-like member has a flat spring portion extending between the cable shield and the casing and contacting both the cable shield and the casing.

### CROSS-REFERENCE TO RELATED APPLICATION

This application claims the benefit of the filing date under 35 U.S.C. § 119(a)-(d) of Japanese Patent Application No. 2023-042280, filed on Mar. 16, 2023.

### FIELD OF THE INVENTION

The present disclosure relates to a cable connector assembly and, more particularly, to a cable connector assembly having a cable to be electrically connected.

### BACKGROUND

Japanese Patent No. 6814269 (hereinafter “JP 6814269”) discloses a connector for connecting a multicore cable to an electrical apparatus. Such a connector is provided with an electromagnetic shield structure that electrically shields a cable attached to the connector and a terminal provided in the connector in order to suppress emission of electromagnetic waves to the outside and/or penetration of electromagnetic waves from the outside due to signals transmitted to the electrical apparatus.

In the connector described in JP 6814269, for example, a shield braid of the cable and the connector accommodating one end of the cable are electrically connected by a connecting member. The connecting member is composed of a tubular portion and a spring tab, the tubular portion is arranged on an inner peripheral side of the shield braid, the spring tab projects through the shielding braid so as to reach an inner wall of the connector located around an outer peripheral side of the shield braid, and thereby the shield braid and the connector are connected.

Such a connection structure as described above, however, requires making the spring tabs provided on the tubular portion of the connecting member penetrate the shield braid when attaching the connecting member. Such a task can be relatively complicated, and in particular, if the connector is of a small size, the task becomes finicky, and requires significant time to assemble the connector.

### SUMMARY

A cable connector assembly includes a connector having a casing and a ring-like member and a cable connected to the connector. The cable has an internal cable and a cable shield surrounding the internal cable. The casing accommodates an end of the cable. The ring-like member is positioned around the cable inside the casing. The ring-like member has a flat spring portion extending between the cable shield and the casing and contacting both the cable shield and the casing.

### BRIEF DESCRIPTION OF THE DRAWINGS

Features of the present invention will become more apparent by describing in detail exemplary embodiments thereof with reference to the accompanying drawings, in which:

FIG. 1 is an isometric view schematically showing a cable connector assembly according to an embodiment of the present disclosure;

FIG. 2 is an exploded isometric view schematically showing a cable connector assembly according to an embodiment of the present disclosure;

FIG. 3 is an exploded isometric view schematically showing a cable connector assembly according to an embodiment of the present disclosure;

FIG. 4 is an isometric view schematically showing a cable according to an embodiment of the present disclosure;

FIG. 5 is a cross-sectional view schematically showing a cross section A-A of the cable shown in FIG. 4;

FIG. 6A is an isometric view schematically showing a ring-like member according to an embodiment of the present disclosure;

FIG. 6B is a side view schematically showing a ring-like member according to an embodiment of the present disclosure;

FIG. 6C is a side view schematically showing a ring-like member according to an embodiment of the present disclosure;

FIG. 7A is an isometric view schematically showing a ring-like member according to another embodiment of the present disclosure;

FIG. 7B is a side view schematically showing a ring-like member according to another embodiment of the present disclosure;

FIG. 8 is a side view schematically showing a casing according to an embodiment of the present disclosure;

FIG. 9 is a cross-sectional view schematically showing a cross section B-B of the casing shown in FIG. 8;

FIG. 10 is a side view schematically showing a cable connector assembly according to an embodiment of the present disclosure;

FIG. 11 is a cross-sectional view schematically showing a cross section C-C of the cable connector assembly shown in FIG. 10;

FIG. 12 is a schematic enlarged view of a portion I of the cable connector assembly shown in FIG. 11;

FIG. 13 is a top view schematically showing a cable connector assembly of the present disclosure;

FIG. 14 is a cross-sectional view schematically showing a cross section D-D of the cable connector assembly shown in FIG. 13;

FIG. 15 is an exploded isometric view schematically showing a cable connector assembly including an intermediate sealing member in an embodiment of the present disclosure;

FIG. 16A is an isometric view schematically showing an intermediate sealing member according to an embodiment of the present disclosure;

FIG. 16B is a side view schematically showing an intermediate sealing member according to an embodiment of the present disclosure;

FIG. 16C is a side view schematically showing an intermediate sealing member according to an embodiment of the present disclosure;

FIG. 17 is a side view schematically showing a combined state of a ring-like member and an intermediate sealing member according to an embodiment of the present disclosure;

FIG. 18 is a cross-sectional view schematically showing the cross section C-C of the cable connector assembly including the intermediate sealing member in an embodiment of the present disclosure;

FIG. 19 is a schematic enlarged view of a portion II of the cable connector assembly shown in FIG. 18; and

FIG. 20 is a cross-sectional view schematically showing the cross section D-D of the cable connector assembly including the intermediate sealing member in an embodiment of the present disclosure.

### DETAILED DESCRIPTION OF EMBODIMENTS

A cable connector assembly according to an embodiment of the present disclosure will be described in more detail below with reference to the drawings. A variety of elements in the drawings are schematically and illustratively shown only for the purpose of description of the present disclosure, and may be different in appearance, dimension ratio, and/or the like, from actual ones.

Further, in the following description, terms representing particular directions or positions are used where necessary. These terms, however, are used to facilitate understanding of the invention with reference to the drawings, and the technical scope of the present disclosure is not limited by the meanings of these terms. In addition, identical or equivalent portions are denoted by an identical reference sign in the plurality of drawings. Sizes, positional relationships, and/or the like, of members shown in each of the drawings may be exaggerated for the purpose of clear description.

In addition, description of an illustrative aspect of the present disclosure is intended to be read with reference to the accompanying drawings (drawings deemed to be part of the entire written description). In a description about an embodiment of the present disclosure disclosed herein, a reference to a direction or orientation is only for convenience of description, and is not intended to limit the scope of the present disclosure. Relative terms, such as “below”, “above”, “horizontal”, “vertical”, “up”, “down”, “top”, and “bottom”, and their derivatives, such as “horizontally”, “downward”, and “upward”, should be interpreted as referring to a direction as written or as shown. Such relative terms are only for convenience of description, and do not require an apparatus to be configured or operated in a particular direction, unless otherwise explicitly described. In addition, unless otherwise explicitly described, terms such as “attached”, “added”, “connected”, “coupled”, and “interconnected”, and their similar terms indicate that structures have a relationship in which they are directly or indirectly fixed or attached to each other with an interposed object therebetween, and/or that they are mutually movably or rigidly attached or have such a relationship.

Features and advantages of the present disclosure are illustrated with reference to an embodiment. Such an embodiment is so fully described in detail that a person skilled in the art can practice the present disclosure. It should be appreciated that another embodiment can also be used, and a process, electrical, or mechanical modification may be made without departing from the scope of the present disclosure. Configurations may be shown in separate embodiments for convenience, but those shown in the different embodiments may be partially interchanged or combined. Therefore, the present disclosure is explicitly not limited to an embodiment (an embodiment that stands alone or that is combined with another feature) illustrating a non-limiting combination of possible features. In embodiments described below, a description about a matter in common with an embodiment already described will be omitted, and only a difference therebetween will be described. In particular, like actions and effects attributable to like configurations will not be mentioned every time for each embodiment.

The features of the present disclosure are associated with an electromagnetic shield structure of a cable connector assembly. Here, however, in order to understand an overall structure of the cable connector assembly, the cable connector assembly will be briefly described below with reference to the drawings.

### <Basic Structure of a Cable Connector Assembly>

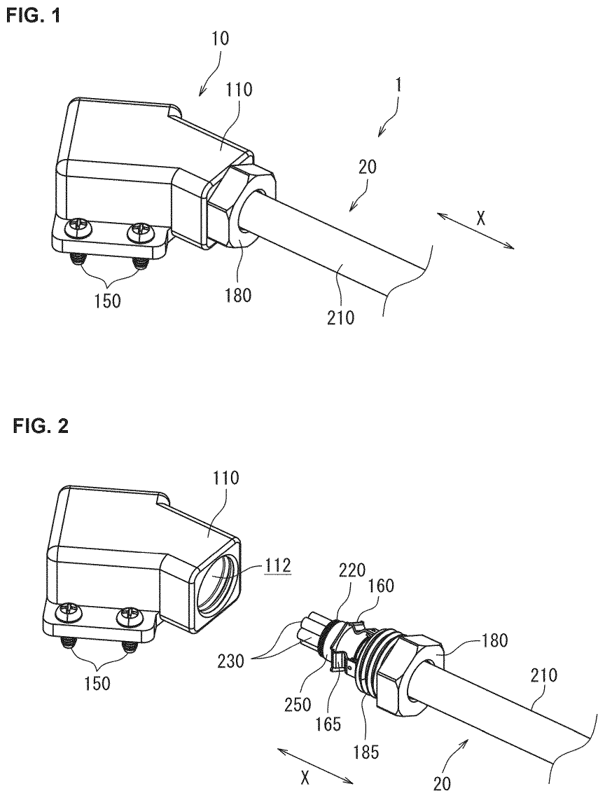

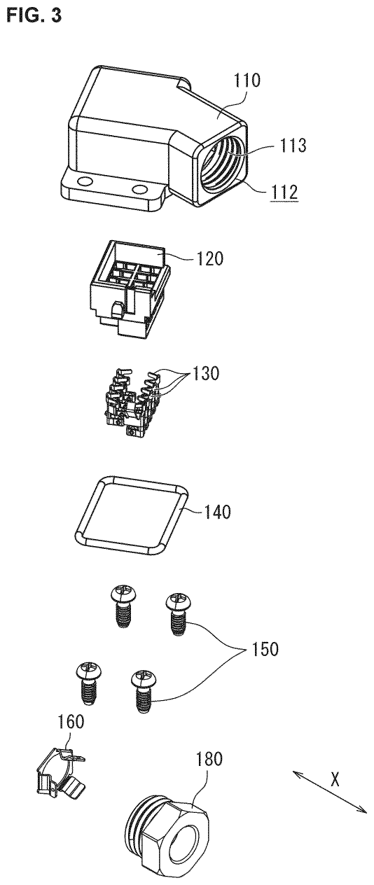

FIG. 1 is an isometric view schematically showing a cable connector assembly 1 according to an embodiment of the present disclosure. FIGS. 2 and 3 are each an exploded isometric view of a cable connector assembly in an embodiment of the present disclosure. The cable connector assembly 1 includes a connector 10 and a cable 20 connected to the connector 10. Though not shown, the cable connector assembly 1 may be combined with a device (for example, electrical equipment such as a servomotor), and the device may be electrically connected to an internal cable 230 included in the cable 20. For example, the cable connector assembly I may be combined with the device, and may be fixed thereto with a suitable fastener, such as a bolt 150.

It should be noted that the “assembly” in the present disclosure is equivalent to a composite article or a combined article that is composed of a plurality of components. Therefore, the cable connector assembly 1 of the present disclosure may be equivalent to a connector composite article or a connector combined article that is at least composed of the cable 20 and the connector 10 attached to an end of the cable 20.

The connector 10 may include a casing 110 and an internal housing 120 arranged inside the casing 110, as shown in FIG. 3. The internal housing 120 accommodates a terminal 130 electrically connected to the internal cable 230 of the cable inserted into the casing 110. The casing 110 and the internal housing 120 may also be referred to as an outer housing and an inner housing, respectively, because of their relative positional relationship.

The casing 110 may have a hollow substantially boxy shape, and may be opened in its main face located in a direction in which the cable connector assembly 1 is combined with the device. In addition, an insertion port through which the cable 20 can be passed may be formed in at least one side face of the casing 110. In the cable connector assembly 1 of the present disclosure, the cable 20 combined with the connector 10 is led out of the casing 110 through the insertion port 112 (see FIG. 1). The insertion port 112 may have a tubular shape protruding to the outside of the casing 110. One end of the cable 20 inserted into the casing 110 through the insertion port 112 is accommodated in the casing 110. From this end of the cable 20, the internal cable 230 extends toward the internal housing 120 by a predetermined length, and a leading end of the internal cable 230 is electrically connected to the terminal 130 accommodated in the internal housing 120.

The casing 110 may be formed from an electrically conductive material. Alternatively, the casing 110 may be formed from a material having a surface plated or otherwise treated so as to have electrical conductivity. For example, the casing 110 can be a member whose surface has electrical conductivity imparted by plating a resin material with metal. That is, the casing 110 may be so formed as to have electrical conductivity at least on its outer surface and inner surface.

The internal housing 120 is configured to support the terminal 130 connected to the internal cable 230 (see FIG. 3). With the device combined with the connector 10, each terminal 130 accommodated in the internal housing 120 may be connected to its corresponding terminal 130 included in the device.

The internal housing 120 may be formed from an electrically insulating material. For example, the electrically insulating material may be a resin material having an electrical insulation property. Though not particularly limited, the resin material can be, for example, at least one kind of thermosetting resin selected from the group consisting of an epoxy resin, a phenolic resin, a silicone resin, and an unsaturated polyester resin.

In addition, in an embodiment of the present disclosure, the connector 10 may have a sealing member such as a watertight packing 140. The packing 140 may be provided at a joint between the casing 110 and the device, for example along a peripheral edge of the casing 110. This fills a gap that may occur at a place where the connector 10 and the device are combined, so that electrical elements such as the internal cable 230 and the terminal 130 accommodated in the connector 10 can be properly waterproofed.

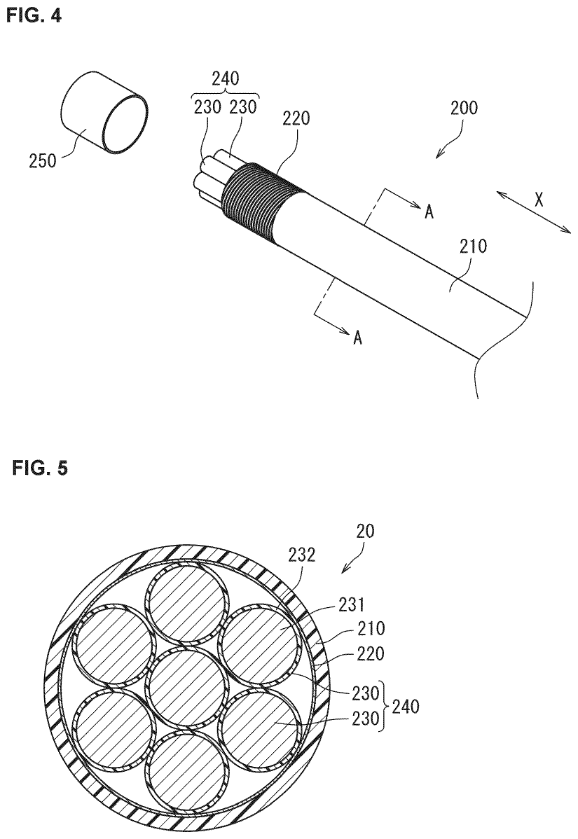

FIG. 4 is a schematic isometric view of a cable 20 according to an embodiment of the present disclosure. FIG. 5 is a schematic cross-sectional view of the cable 20 in a cross section A-A shown in FIG. 4. The cable 20 includes an internal cable bundle 240 composed of a plurality of internal cables 230, a cable shield 220 surrounding the internal cable bundle 240, and an electrically insulating covering member 210 surrounding the cable shield 220. As shown, each of the plurality of internal cables 230 may be formed by covering an outer periphery of a conducting wire 231 such as a pure copper wire or a tinned copper wire with an electrically insulating internal cable coating 232. The plurality of internal cables 230 constitute the internal cable bundle 240, and an outer periphery of the internal cable bundle 240 is surrounded by the cable shield 220. The covering member 210 covers an outer periphery of the cable shield 220 and defines an outer periphery of the cable 20. Such a covering member 210 may also be referred to as a cable jacket. It should be noted that, for the purpose of clear description, an illustration of the internal cables may be omitted in the following drawings.

The cable shield 220 is formed from an electrically conductive material in order to electrically shield the internal cable bundle 240. In an embodiment, the electrically conductive material used for the cable shield 220 be an electrically conductive material having flexibility because it is advantageous in routing to equipment or the like arranged in a narrow space. In particular, the cable shield 220 according to an embodiment of the present disclosure may be a braid formed from a plurality of electrically conductive wires such as electrically conductive strands or fibers having excellent durability and flexibility. Though not particularly limited, the braid used for the cable shield of the present disclosure may be formed from a material having excellent electrical conductivity, such as copper, a copper alloy, aluminum, or an aluminum alloy. In addition, the material may be formed with an electrically conductive plating layer on its surface, such as tin plating, nickel plating, or sliver plating, in order to prevent oxidation or rust formation.

The covering member 210 may be formed from an electrically insulating material. If importance is placed on an advantage in routing of the cable 20, the covering member 210 be a flexible electrically insulating material. For example, the covering member 210 may be formed from a polymer or the like, such as polyvinyl chloride (PVC), polypropylene, a fluoropolymer, polyethylene, and/or the same kind of polymer as those.

The cable shield 220 may be exposed at the end of the cable 20 accommodated in the casing 110 (see FIG. 4). For example, as shown in FIG. 4, the outermost peripheral covering member 210 may be removed from the end of the cable 20, and the cable shield 220, as a whole, may be folded over the covering member 210. Consequently, at the end of the cable 20, the cable shield 220 is arranged around the outermost periphery of the cable 20. A ring-like member 160 may be arranged around the exposed cable shield 220.

Alternatively, an electrically conductive tape 250 may be arranged around the exposed cable shield 220. For example, as shown in FIG. 2, the electrically conductive tape 250 may be wrapped around the folded cable shield 220. The ring-like member 160 may be arranged around the electrically conductive tape 250. That is, the cable shield 220 and the ring-like member 160 may have electrical continuity via the electrically conductive tape 250. Though the material of the electrically conductive tape 250 is not particularly limited, a metal foil such as a copper foil, for example, can be used.

The cable connector assembly of the present disclosure has a feature in an electromagnetic shield structure for electrically shielding the internal cable 230 and the terminal 130 connected to the internal cable 230. In particular, the cable connector assembly of the present disclosure has a feature in a connection mechanism between the cable shield 220 surrounding the internal cable bundle 240 and the casing 110 surrounding the internal cable 230 and the terminal 130 inside the connector 10.

### <Features of the Cable Connector Assembly of the Present Disclosure>

The casing 110, the cable shield 220, and the ring-like member 160 connecting the casing 110 and the cable shield 220 are involved in an electromagnetic shield configuration in the cable connector assembly of the present disclosure. In an embodiment, a threaded member 180 combined with the insertion port 112 of the casing is further involved. In another embodiment, an intermediate sealing member 170 arranged between the threaded member 180 and the ring-like member 160 is also used in the electromagnetic shield configuration. The electromagnetic shield configuration in the cable connector assembly of the present disclosure will be described in detail below.

### <Ring-Like Member>

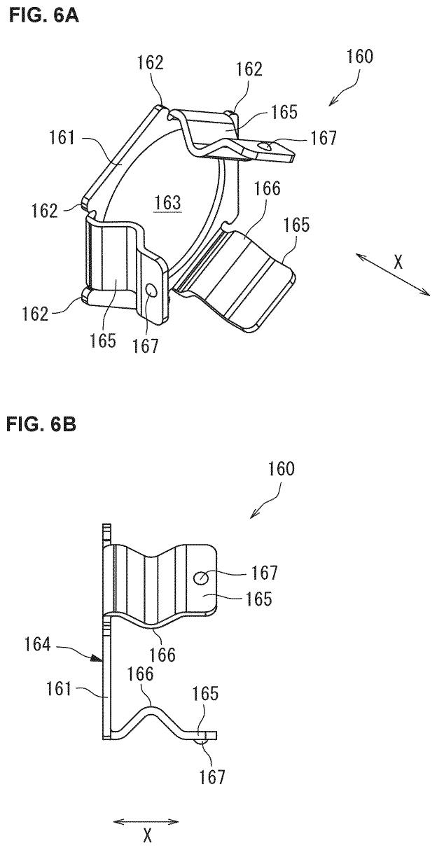

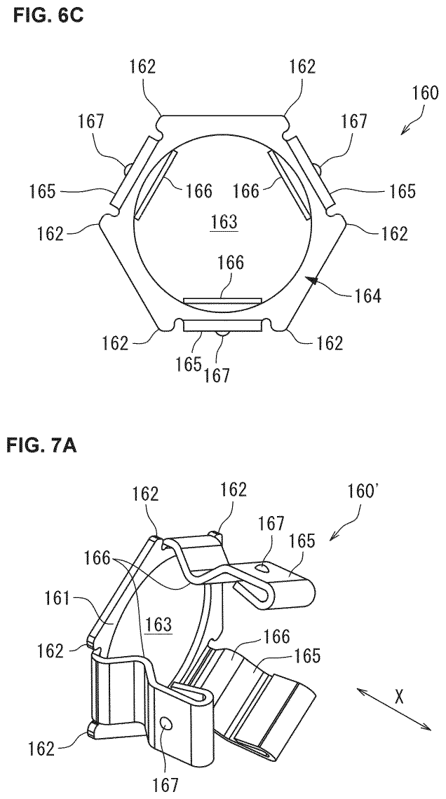

In the cable connector assembly of the present disclosure, an electrical connection between the cable shield 220 and the casing 110 to configure an electromagnetic shield is achieved using the ring-like member 160 arranged inside the casing 110. As shown in FIG. 2, the ring-like member 160 with the cable 20 passed therethrough is arranged inside the casing 110. Hence, the ring-like member 160 can also be referred to as an “internal ring-like member” or the like. FIGS. 6A to 6C are schematic views of the ring-like member 160 according to an embodiment of the present disclosure. The ring-like member 160 is an electrically conductive member, and includes a base portion 161 through which the cable 20 is passed, and a flat spring portion 165 extending from an end of the base portion 161 along an extension direction X of the cable 20 as a whole.

Though a contact structure between the ring-like member 160 and the cable shield 220 will be described below, this structure is similar to a contact structure between the ring-like member 160 and the electrically conductive tape 250 in a mode including the electrically conductive tape 250. That is, in a case where the electrically conductive tape 250 is applied to the cable shield 220, features and their effects regarding connection between the ring-like member 160 and the electrically conductive tape 250 are similar to features and their effects regarding connection between the ring-like member 160 and the cable shield 220 that will be described below.

The base portion 161 of the ring-like member 160 may have a ring-like shape including a through-hole 163 through which the cable 20 can be passed. That is, the ring-like member 160 of the present disclosure is positioned around the cable 20 at the through-hole 163 of the base portion 161. In other words, the cable 20 may extend through the through-hole 163 of the ring-like member 160 inside the casing 110. The term “ring-like” herein may not necessarily mean a perfect circle, and it includes an imperfect circular shape such as an elliptical shape, and any shape such as a polygonal shape. In addition, ring-like may not necessarily mean being completely continuous in its peripheral direction, and it may be a partially cutaway shape (for example, a C-ring-like or the like).

In an embodiment, the base portion 161 has a shape whose entire periphery is closed. In other words, the through-hole 163 through which the cable 20 is passed may be a hole whose entire periphery is closed. That is, as seen from the extension direction X of the cable 20, the base portion 161 may have such a continuous shape as to close the entire periphery of the through-hole 163, not a partially cutaway discontinuous shape. Such a structure can distribute a force that may be applied to the base portion 161 more evenly over the entire base portion 161, so that the ring-like member 160 that is more favorable in terms of strength can be achieved.

As shown in FIGS. 6A to 6C, the flat spring portion 165 extending from the end of the base portion 161 extends as a whole in a direction crossing an extension direction of the base portion 161. For example, the extension direction of the flat spring portion 165 may be a direction substantially perpendicular to an extension direction of a main face of the base portion 161 including the through-hole 163.

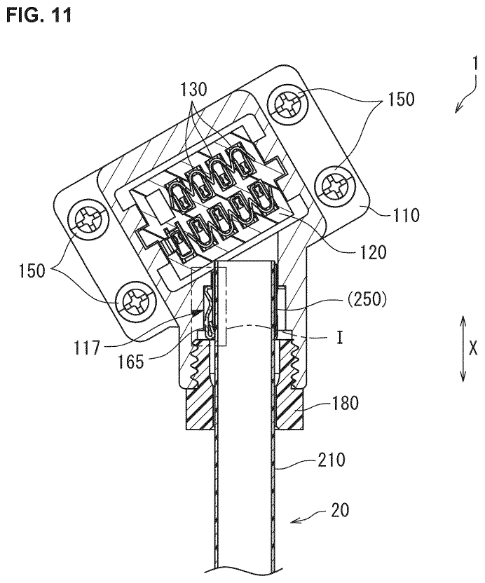

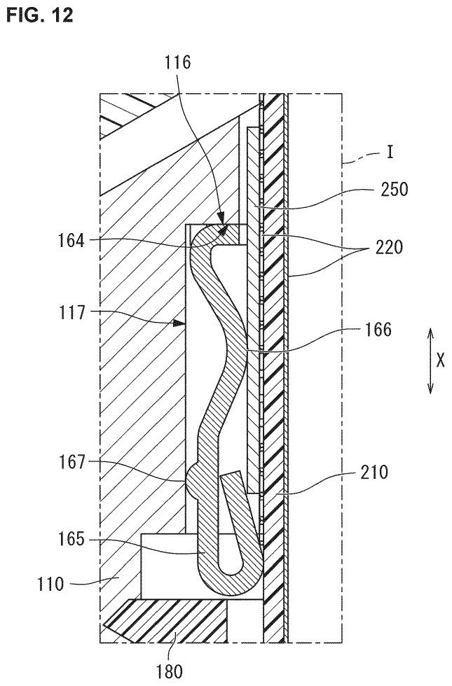

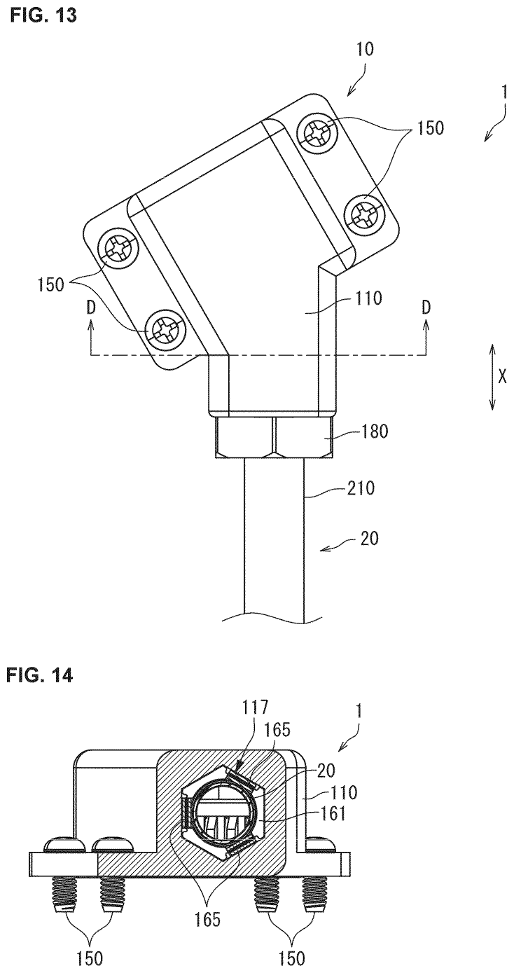

FIG. 11 is a cross-sectional view of the cable connector assembly 1 according to an embodiment of the present disclosure. In addition, FIG. 12 is a partially enlarged view of a portion I in FIG. 11. As shown, the flat spring portion 165 of the ring-like member may extend along the extension direction X of the cable in a gap between the cable 20 and the casing 110. The flat spring portion 165 can contact both the cable 20 and the casing 110 in this gap. More specifically, the flat spring portion 165 may be capable of elastic contact with both the cable shield 220 exposed at the end of the cable 20 and the casing 110. As shown in FIGS. 11 and 12, the flat spring portion 165 is configured to contact the cable shield 220 folded over the covering member 210, and also to be capable of contact with an inner side face 117 of the casing 110. That is, the flat spring portion 165 may include a first contacting portion 166 that mutually contacts the cable shield 220 located around the outermost periphery of the cable 20, and a second contacting portion 167 that mutually contacts the inner side face of the casing 110. As described above, the ring-like member 160 is an electrically conductive member. Therefore, in such a structure, the cable shield 220 and the casing 110 can be electrically connected to each other via the flat spring portion 165.

According to such a structure, the flat spring portion 165 is arranged inside the casing 110 between the cable shield 220 and the casing 110, and thereby the cable shield 220 and the casing 110 are electrically connected to each other to configure an electromagnetic shield of the cable connector assembly. This can be achieved by positioning the ring-like member 160 around the cable 20 with the cable shield 220 exposed inside the casing 110. That is, according to the present disclosure, the electromagnetic shield can be more easily configured without necessarily requiring a task that is performed using an additional tool, such as swaging or welding. In the present disclosure, with the ring-like member 160 positioned around the cable 20 inserted in the casing 110, the connection between the cable shield 220 and the casing 110 can be achieved simply by an easy operation of moving the ring-like member 160 into the casing 110 along the cable 20. Therefore, the cable connector assembly of the present disclosure can include an electromagnetic shield configuration that is more favorable in terms of case of assembly.

The flat spring portion 165, though extending along the extension direction X of the cable as a whole, may be partially bent. More specifically, as shown in FIG. 12, the flat spring portion 165 may include a bend that is so bent as to form a peak along a radial direction of the cable. The flat spring portion 165 may be bent at least at part thereof so as to protrude in a substantially V-shape along the radial direction of the cable. The flat spring portion 165 may be in mutual clastic contact with the cable shield 220 and/or the casing 110 at the bend. For example, the flat spring portion 165, at the first contacting portion 166, may be so angled as to be inclined toward the cable shield 220 (that is, toward the inside of the casing 110), brought into contact with the cable shield 220, and then so angled as to be folded toward the casing 110 (that is, toward the outside of the casing 110). In addition, for example, the flat spring portion 165, at the second contacting portion 167, may be angled toward the casing 110, brought into contact with the casing 110, and then so angled as to be folded toward the cable shield 220.

The flat spring portion 165 may be bent at the first contacting portion 166 and/or the second contacting portion 167. For example, as shown in FIG. 12, the flat spring portion 165 may be so bent as to form a peak at either one of the first contacting portion 166 and the second contacting portion 167, while extending along the extension direction X of the cable with no bend at the other contacting portion. In an embodiment, the flat spring portion 165 is so bent as to protrude toward the cable shield 220 at the first contacting portion 166, while extending along an internal face of the casing 110 at the second contacting portion 167 (see FIGS. 6A to 6C, and 12). Alternatively, the flat spring portion 165 may include bends at both the first contacting portion 166 and the second contacting portion 167. The flat spring portion 165 includes the above-described bend at least at part thereof, and thereby the flat spring portion 165 can more favorably exert an elastically biasing force on the casing 110 and the cable shield 220. That is, the above-described structure enables the flat spring portion 165 to come into tight contact with both the casing 110 and the cable shield 220 more favorably, so that connection reliability between the cable shield 220 and the casing 110 can be improved.

It should be noted that “bend” or “bent” in the present disclosure encompasses angled, curved, or even folded. That is, in a side view shown in FIG. 6B, or in a cross-sectional view as shown in FIG. 12, the flat spring portion 165 may be substantially curvilinearly (for example, in an arc-like manner) bent in a rounded manner, or may be substantially linearly bent in an angular manner. Such a bent shape can also be referred to as, for example, a “folded shape”, “dogleg shape”, “substantially U-shape”, “substantially V-shape”, or “a curvilinear shape having a vertex”, or the like.

In addition, as shown in FIGS. 6A to 6C, the flat spring portion 165 may include at least one bump 167 at a portion in contact with the casing 110. The bump 167 may protrude toward the casing 110 from a main face of the flat spring portion 165 facing the inner surface of the casing 110. In such a structure, the flat spring portion 165 and the casing 110 may be in contact with each other at the bump 167. In other words, the second contacting portion 167 of the flat spring, which contacts the casing 110, can be the bump 167 provided on the flat spring portion 165.

The flat spring portion 165 includes the bump 167 that can abut the casing 110, and thereby a point of contact between the flat spring portion 165 and the casing 110 can be achieved more reliably than in a case where they come into surface contact with each other. Further, the presence of the bump 167 enables the flat spring portion 165 to exert the elastic biasing force more favorably on the casing 110. Further, the elastic biasing force on the cable shield 220 located on the opposite side to the casing 110 can also be increased. Therefore, according to the present disclosure, an electromagnetic shield configuration can be achieved that has, in addition to a high degree of case of assembly, higher connection reliability in the electrical connection between the cable shield 220 and the casing 110. Though not shown, alternatively, the flat spring portion 165 may also include a bump at the portion 166 in contact with the cable shield 220.

If more importance is placed on case of assembly, connection reliability, and the like of the ring-like member 160, the first contacting portion 166 and the second contacting portion 167 may be adjacent to each other in the extension direction of the flat spring portion 165 (that is, the extension direction X of the cable 20). For example, the first contacting portion 166 may be located relatively at a proximal end side of the flat spring portion 165 (that is, the base portion 161 side), and the second contacting portion 167 may be located relatively at a distal end side of the flat spring portion 165, or they may have a positional relationship opposite to the above. That is, as shown in FIG. 12, the flat spring portion 165 may contact the cable shield 220 at its proximal end side, and may mutually contact the casing 110 at its distal end side.

In addition, the base portion 161 of the ring-like member may be arranged nearer to the internal housing 120 than the flat spring portion 165. On the other hand, the flat spring portion 165 may be arranged farther from the internal housing 120 than the base portion 161. That is, the base portion 161 may be located at the one end side of the cable 20 accommodated in the casing 110, and the flat spring may extend toward an other end of the cable 20. In such a structure, the flat spring portion 165 can also be understood to extend in a direction in which the cable 20 is led out of the casing 110.

According to such a configuration, when the cable connector assembly is assembled, the ring-like member 160 is positioned around the cable 20, with the cable 20 extending through the ring-like member 160, in such a manner that the base portion 161 is located at the leading end side of the cable 20, and the ring-like member 160 is inserted into the casing 110 along the cable 20. At this time, since the ring-like portion 160 is inserted into the casing 110 with the base portion 161 first, the flat spring portion 165 is inserted into the casing 110 with the proximal end side first. Therefore, the flat spring portion 165 having the elastic biasing force in the radial direction of the cable can be more smoothly inserted into the casing 110, so that the members for constituting the electromagnetic shield can be more easily assembled.

The ring-like member 160 of the present disclosure is an electrically conductive member. The base portion 161 of the ring-like member and the flat spring portion 165 extending from the base portion 161 may be an integrated article. The ring-like member 160 may be formed by processing a sheet metal material. More specifically, for example, the through-hole 163 may be formed by punching a sheet metal material, and the flat spring portion 165 may be formed by bending an elongated tab extending from the base portion 161 including the through-hole 163.

A plurality of flat spring portions 165 described above may be provided. That is, in an embodiment of the present disclosure, the ring-like member 160 may include the plurality of flat spring portions 165 arranged at a predetermined interval along the contour of the base portion 161. The ring-like member 160 includes the plurality of flat spring portions 165, and thereby a plurality of connection locations between the cable shield 220 and the flat spring portions 165 and a plurality of connection locations between the casing 110 and the flat spring portions 165 can be provided. Further, since the flat spring portions 165 can exert the elastic biasing force on the cable 20 from a plurality of directions, the position of the cable 20 is favorably retained, and even the connection reliability can also be improved.

As described above, the ring-like member 160 of the present disclosure achieves the electromagnetic shield configuration that is more favorable in terms of case of assembly, using the flat spring portion 165 connecting the cable shield 220 and the casing 110. The cable connector assembly of the present disclosure may further include a feature that, though not directly involved in the electrical connection, can achieve a further improvement of the case of assembly. For example, the cable connector assembly of the present disclosure further includes features that will be described below about the base portion 161 continuous from the flat spring portion 165, and about other members associated with the ring-like member 160, and can thereby achieve a further improvement of the case of assembly.

In the ring-like member 160 of the present disclosure, the base portion 161 may include an abutting face 164 extending along a direction crossing the extension direction X of the cable (for example, the radial direction of the cable passed through the through-hole 163) and capable of abutting an inner wall face 116 of the casing 110 (see FIGS. 6B and 12). In other words, the casing 110 may be capable of abutting the abutting face 164 of the base portion of the ring-like member 160 on the inner wall face 116 extending along the radial direction of the cable. For example, the base portion 161 may include the abutting face 164 around a peripheral edge of the through-hole 163.

Such an abutting face 164 can assist in retaining the position of the ring-like member 160 inside the casing 110. Specifically, the ring-like member 160 accommodated in the casing 110 with the cable passed therethrough is prevented from entering the casing 110 further by the abutting face 164 of the base portion abutting the inner wall face 116 of the casing 110. In such a structure, the inner wall face 116 of the casing 110 can abut the abutting face 164 of the base portion, and hence can also be referred to as an abutted face 116. That is, when the ring-like member 160 is attached, the abutting face 164 of the base portion and the abutted face 116 of the casing 110 abut each other, and thereby the ring-like member 160 can be arranged in position.

FIG. 6C is a side view of the ring-like member 160 according to an embodiment of the present disclosure, as seen from the extension direction X of the cable. The base portion 161, as seen from the extension direction X of the cable, may include a corner 162 at least at part thereof. The base portion 161, as seen from the extension direction X of the cable, may have, at least at part thereof, a contour shape including the corner 162 protruding toward the inner side face 117 of the casing. That is, the contour shape of the base portion 161 may not be circular. The base portion 161 may be capable of abutting the inner side face 117 of the casing at the corner 162. It should be noted that the inner side face 117 of the casing means a side face extending along the extension direction X of the cable inside the casing 110. More specifically, the inner side face 117 encompasses a side face inside the insertion port 112 of the casing which the ring-like member 160 is arranged. According to the structure of the present disclosure, the corner 162 abuts the inner surface of the casing 110, and thereby movements of the ring-like member 160 inside the casing 110 can be restricted. In particular, the ring-like member 160 can be prevented from rotating in the radial direction of the cable.

A relative movement such as rotation of the ring-like member 160 inside the casing 110 can cause a resistance value increase due to a connection failure and/or rubbing of the members against each other at a point of contact between the flat spring portion 165 and the cable shield 220 or between the flat spring portion 165 and the casing 110. According to the cable connector assembly of the present disclosure, however, since the ring-like member 160 is properly retained inside the casing 110, occurrence of such a connection failure or rubbing is suppressed, so that the electromagnetic shield that is more favorable in terms of connection reliability can be achieved.

For example, the contour shape of the base portion 161 may be a polygonal shape. For example, the contour shape of the base portion 161 may be substantially hexagonal, as shown in FIG. 6C, or may be another polygonal shape, such as a quadrilateral or pentagon. The at least one corner 162 in a polygonal shape abuts the inner surface of the casing 110, and thereby the position of the ring-like member 160 can be favorably retained inside the casing 110.

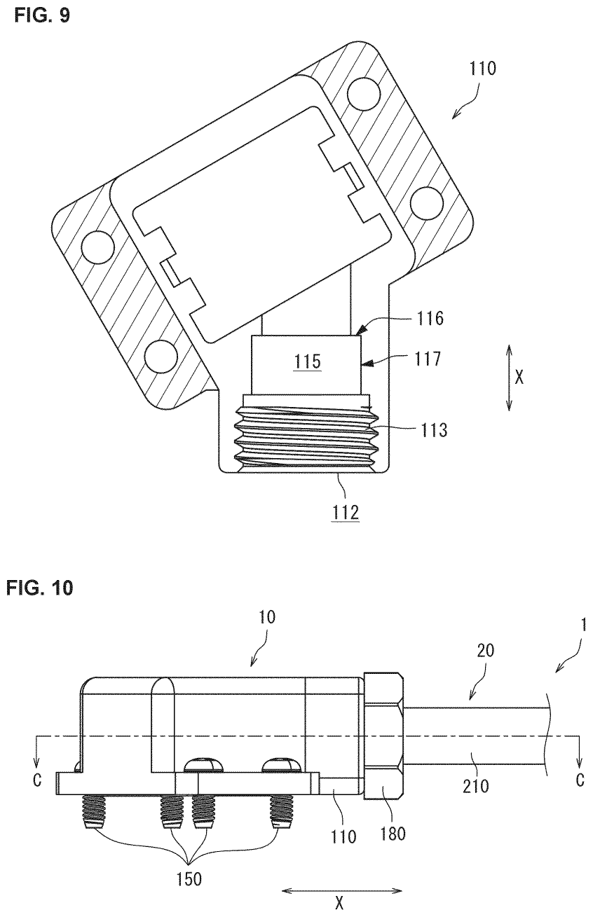

In an embodiment, an internal space in the casing 110 where the ring-like member 160 is located may have a shape complementary to the contour shape of the base portion 161 (see FIGS. 8 and 9). As shown, a ring-like member accommodation region 115 where the ring-like member 160 is positioned inside the casing 110, as seen from the extension direction X of the cable, may have a shape matching with the contour shape of the base portion 161 of the ring-like member. In such a structure, the ring-like member accommodation region 115, as seen from the extension direction X of the cable, may have a shape including at least one corner 162.

When the base portion 161 of the ring-like member is polygonal, the ring-like member accommodation region 115 of the casing 110 may have a space in a polygonal prismatic shape corresponding to the polygonal shape of the base portion 161. For example, as shown in FIGS. 6C and 8, respectively, the base portion 161 of the ring-like member and the ring-like member accommodation region 115 of the casing 110, as seen from the extension direction X of the cable, may both have a substantially hexagonal shape. The base portion 161 of the ring-like member is so accommodated as to fit in the ring-like member accommodation region 115 defined by inner side faces 117 of the casing 110. This causes the plurality of inner side faces 117 to restrict movements of the corner 162 of the base portion, so that a relative movement such as rattling or rotation of the ring-like member 160 can be more favorably suppressed.

### <Threaded Member>

The threaded member 180 (see FIG. 11) combined with the insertion port 112 of the casing may be further involved in the electromagnetic shield configuration in the cable connector assembly of the present disclosure. The threaded member 180 includes a hollow structure, and the cable 20 led out of the casing 110 can be passed through a hollow portion of the threaded member 180. Hence, the threaded member 180 may also be referred to as a “hollow threaded member” or the like. A thread ridge 185 may be formed on an outer peripheral face of the threaded member 180. In addition, a thread groove 113 capable of engaging with the thread ridge 185 of the threaded member 180 may be formed in an inner peripheral face in the insertion port 112 of the casing (see FIG. 9). Such a structure enables the threaded member 180 to be combined with the inner peripheral face in the insertion port 112 of the casing. That is, when the threaded member 180 and the casing 110 are screwed to each other, the threaded member 180 is so combined as to enter the insertion port 112.

When the cable connector assembly is assembled, the cable 20 is inserted into the casing 110, and then the ring-like member 160 positioned around the cable 20 is moved along the cable 20 and introduced into the casing 110 through the insertion port 112. Thereafter, the threaded member 180 is screwed to the insertion port 112, and thereby the position of the cable 20 led out through the insertion port 112 is retained. At this time, the threaded member 180 is so combined as to be inserted into the insertion port 112, and thereby the ring-like member 160 can be moved deep into the casing 110 as the threaded member 180 is inserted. In other words, when the threaded member 180 enters the insertion port 112 in a rotating manner to be fastened to the insertion port 112, the threaded member 180 abuts the ring-like member 160 at its end, and can thereby push the ring-like member 160 deeper into the casing 110. This causes the ring-like member 160 to move to the ring-like member accommodation region 115 inside the casing 110, so that the ring-like member 160 can be arranged in position for an electrical connection to the cable shield 220 and the casing 110. That is, according to the above-described structure, the ring-like member 160 can be arranged in position by fastening the threaded member 180 without a special tool and a complicated operation.

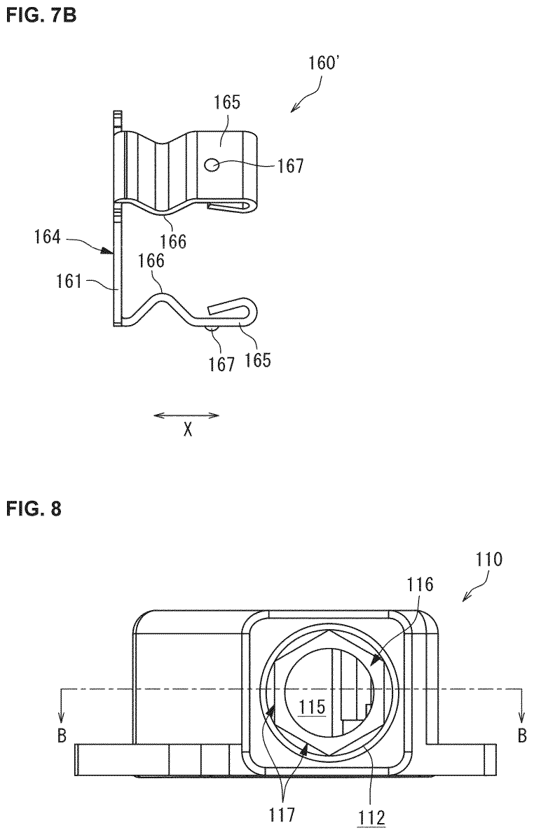

FIGS. 7A and 7B are schematic views of the ring-like member in an embodiment of the present disclosure. As shown, a distal end of the flat spring portion 165 that can abut the threaded member 180 may be so bent as to be folded toward the cable 20. The distal end of the flat spring portion 165 may be angled and folded in a substantially J-shape so as to form a peak toward the extension direction X of the cable. The flat spring portion 165 may include a fold at its distal end, and may be capable of abutting the threaded member 180 in the vicinity of a vertex of the fold. According to such a structure, since a larger abutment area of the threaded member 180 and the flat spring portion 165 against each other is ensured, the movement of the ring-like member 160 into the casing 110 by the threaded member 180 can be more favorably performed. Further, since deformation of the flat spring portion 165 due to the abutment against the threaded member 180 can be suppressed, the present structure can also be favorable in terms of an increase in service life of the cable connector assembly.

### <Intermediate Sealing Member>

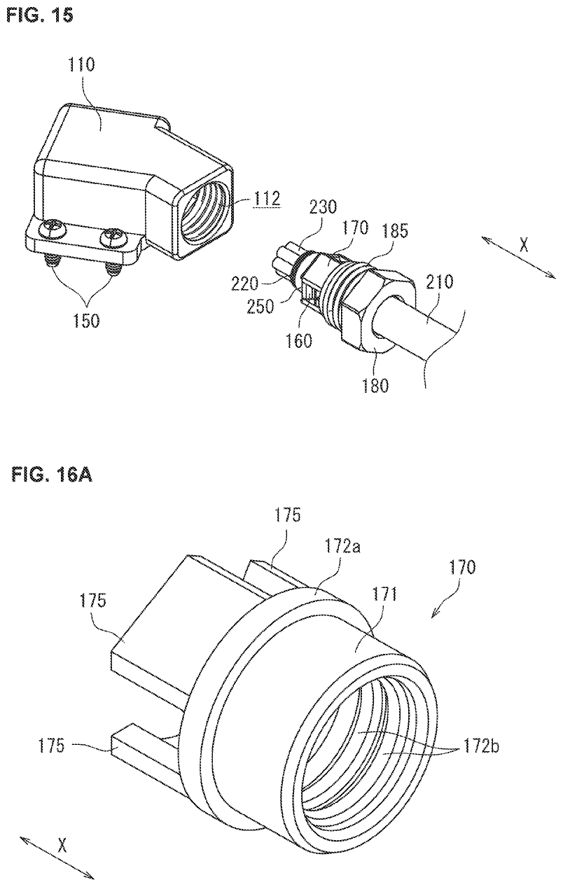

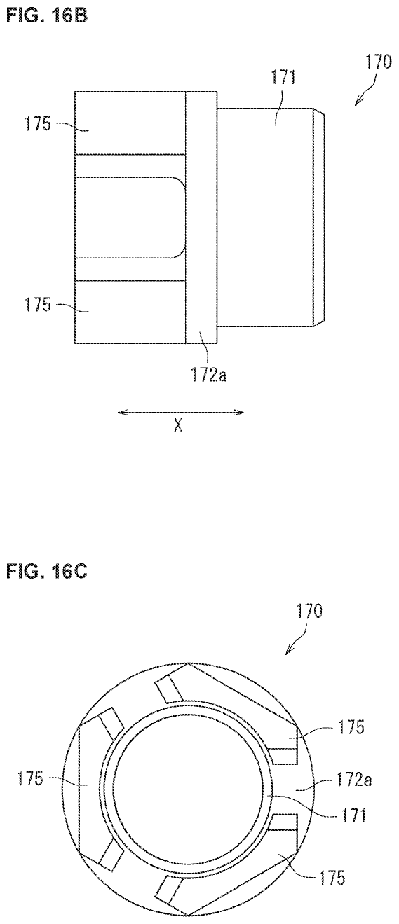

FIG. 15 is a schematic view of a cable connector assembly in another embodiment of the present disclosure. The cable connector assembly of the present disclosure may further include the intermediate sealing member 170 arranged between the ring-like member 160 and the threaded member 180, as a component involved in assembling the electromagnetic shield. FIGS. 16A to 16C are schematic views of the intermediate sealing member 170 in an embodiment of the present disclosure. It should be noted that “intermediate” in the intermediate sealing member 170 means that such a sealing member 170 is positioned between the ring-like member 160 and the threaded member 180 in an assembled state of the cable connector assembly. The intermediate sealing member 170 can also be understood to be a member interposed between the ring-like member 160 and the threaded member 180, and hence can also be referred to as an “interposed sealing member” or the like.

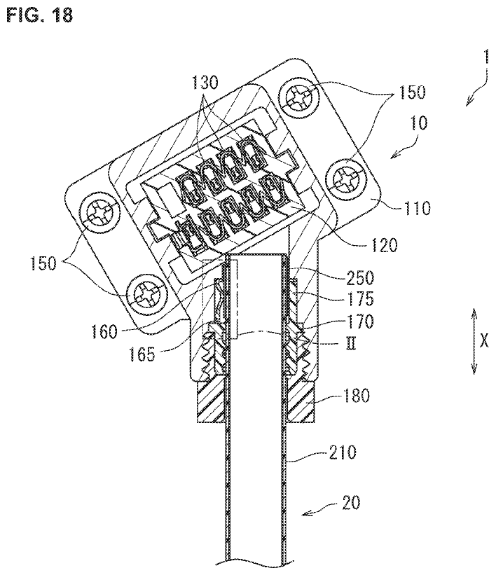

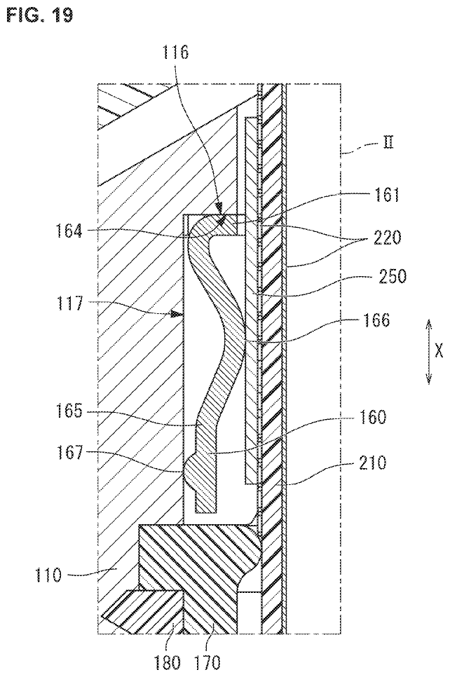

The intermediate sealing member 170 may include a hollow tubular structure, and the cable can be passed through this hollow. The intermediate sealing member 170 positioned around the cable is positioned between the ring-like member 160 and the threaded member 180 inside the insertion port 112 (see FIGS. 18 and 19). A ridge 172a capable of abutting the inner peripheral face in the insertion port 112 may be provided on an outer peripheral face of the intermediate sealing member 170. In addition, a ridge 172b capable of abutting the outer periphery of the cable may be provided on an inner peripheral face of the intermediate sealing member 170. The ridges (172a, 172b) tightly contact the inner peripheral face in the insertion port 112 and/or the outer periphery of the cable, thereby sealing the inside of the casing 110, so that the electrical elements, including the terminal 130 in the casing 110, and the connection locations of the casing 110 and the cable shield 220 with the ring-like member 160, can be favorably protected.

When the cable connector assembly including the intermediate sealing member 170 is assembled, the cable is inserted into the casing 110, and then the ring-like member 160 and the intermediate sealing member 170 positioned around the cable are introduced into the casing 110 in this order through the insertion port 112. Thereafter, by fastening the threaded member 180, the ring-like member 160 and the intermediate sealing member 170 are pushed together into the insertion port 112. That is, the fastening operation of the threaded member 180 causes the intermediate sealing member 170 to be press-fitted into the insertion port 112, and thereby the ring-like member 160 is indirectly moved deep into the casing 110. Therefore, according to the configuration of the present disclosure, an electrical connection between the casing 110 and the cable shield 220, and sealing inside the casing 110 can be achieved simply by an easy operation of combining the threaded member 180 and the insertion port 112. Thus, a more favorable cable connector assembly including an electromagnetic shield configuration with great case of assembly can be achieved.

The intermediate sealing member 170 and the threaded member 180 may be so combined as to overlap partially with each other in the radial direction of the cable. For example, as shown in FIG. 18, the intermediate sealing member 170 may be combined in such a manner that a portion thereof contacts an inner peripheral face of the threaded member 180. More specifically, the intermediate sealing member 170 and the threaded member may be combined in such a manner that a tubular portion 171 of the intermediate sealing member 170 is located on an inner peripheral side of the threaded member.

In addition, a leading end of the threaded member 180 may be capable of abutting the ridge 172a located around an outer peripheral side of the intermediate sealing member 170. According to such a structure, when the threaded member 180 is moved into the casing 110 as the threaded member 180 is fastened, the leading end of the threaded member 180 and the ridge 172a abut each other, and thereby the intermediate sealing member 170 can be moved into the casing 110.

As shown in FIGS. 16A to 16C, the intermediate sealing member 170 may include the tubular portion 171 including the ridge, and a supporting portion 175 extending from the tubular portion 171 along the cable. The supporting portion 175 may have a substantially elongated shape protruding from the tubular portion 171 toward the ring-like member 160. More specifically, the supporting portion 175 may protrude from the tubular portion 171 toward the base portion 161 of the ring-like member (see FIGS. 16A to 19). The supporting portion 175 can retain the position of the cable extending between the ring-like member 160 and the intermediate sealing member 170, so that a state of connection between the cable shield 220 and the casing 110 via the ring-like member 160 can be more favorably retained.

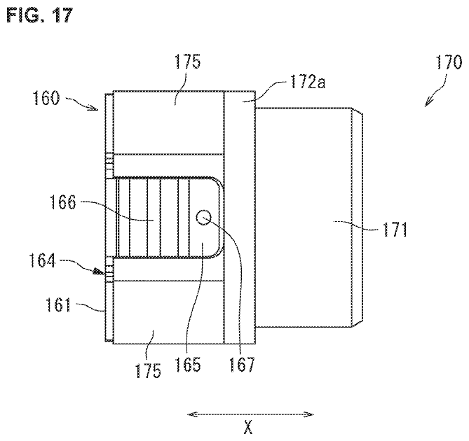

FIG. 17 is a side view showing a combined state of the ring-like member 160 and the intermediate sealing member 170 in an embodiment of the present disclosure. The supporting portion 175 may be positioned in a region where the flat spring portion 165 of the ring-like member is absent. In other words, the flat spring portion 165 may be positioned in a region where the supporting portion 175 of the intermediate sealing member 170 is absent. That is, inside the insertion port 112 of the casing 110, the flat spring portion 165 may extend toward the tubular portion 171 of the intermediate sealing member 170, whereas the supporting portion 175 may extend toward the base portion 161 of the ring-like member in the region where the flat spring portion 165 is not located. According to such a structure, the supporting portion 175 can contribute to favorable retention of the position of the cable under the elastic biasing force exerted by the flat spring portion 165.

In an embodiment, the supporting portion 175, in the region where the flat spring portion 165 is absent, may extend so as to be held in a gap between the cable 20 and the casing 110. In other words, the supporting portion 175 may have a shape corresponding to the shape of the gap between the cable 20 and the casing 110. This enables the cable position to be more favorably retained.

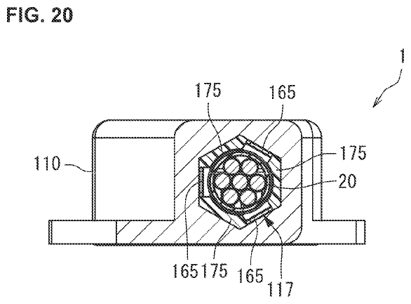

More specifically, the supporting portion 175 may be adjacent to the flat spring portion 165 in a peripheral direction of the cable (see FIGS. 17 and 20). That is, the supporting portion 175 and the flat spring portion 165 may be arranged adjacently to each other along the peripheral direction of the cable. In other words, the supporting portion 175 and the flat spring portion 165 adjacent to each other along the outer periphery of the cable 20 may cover at least a portion of the outer periphery of the cable 20. It should be noted that “adjacent” herein includes not only a case where the supporting portion 175 and the flat spring portion 165 are in contact with each other, but also a case where the supporting portion 175 and the flat spring portion 165 are not in contact with each other and are arranged side by side at a distance from each other.

In an embodiment, a plurality of supporting portions 175 may be provided. In addition, a plurality of flat spring portions 165 of the ring-like member may also be provided. That is, the ring-like member 160 may include a plurality of flat spring portions 165, and the intermediate sealing member 170 may also include a plurality of supporting portions 175. More specifically, the ring-like member 160 may include a plurality of flat spring portions 165 spaced at a predetermined interval along the contour of the base portion 161. Similarly, the intermediate sealing member 170 may also include a plurality of supporting portions 175 spaced at a predetermined interval. In such a structure, the flat spring portion 165 may be positioned between the plurality of supporting portions 175. In other words, the supporting portions 175 may be positioned on opposite sides of the flat spring portion 165 in the peripheral direction of the cable.

In an embodiment, the ring-like member 160 and the intermediate sealing member 170 are combined in such a manner that the flat spring portions 165 and the supporting portions 175 are alternate with each other. That is, as shown in FIGS. 17 and 20, the ring-like member 160 and the intermediate sealing member 170 may be combined in such a manner that the supporting portion 175 fits in between the plurality of flat spring portions 165. The cable 20 may be surrounded, at a portion thereof passed through the ring-like member 160 and the intermediate sealing member 170, by the flat spring portions 165 and the supporting portions 175 arranged alternately.

The flat spring portions 165 and the supporting portions 175 can be alternately combined, and thereby the position of the cable 20 can be favorably retained. Further, according to the above-described structure, since the supporting portions 175 can be arranged on the opposite sides of the flat spring portion 165, a relative movement of the flat spring portion 165 in the peripheral direction of the cable is restricted, so that the connection reliability can be more improved. Therefore, a state of electrical continuity between the flat spring portion 165 and the cable shield 220 can be favorably retained, so that the connection reliability between the cable shield 220 and the ring-like member 160 can be more improved.

In the cable connector assembly of the present disclosure, the ring-like member positioned around the cable is capable of contacting both the cable shield and the casing at the flat spring portion. Therefore, according to this configuration, the cable shield and the casing can be electrically connected to each other via the flat spring portion simply by moving the ring-like member into the casing while positioning the ring-like member around the cable. That is, according to the present disclosure, a more favorable electromagnetic shield that can be assembled by an easier operation of moving the ring-like member along the cable can be provided.

Embodiments of the present invention have been described above, but the present invention is not limited to these embodiments, and various modifications based on knowledge of a person skilled in the art, such as combining the above-described configurations, may be made without departing from the spirit of the scope of the patent claims.

What is claimed is:

1. A cable connector assembly, comprising:
a connector having a casing and a ring-like member; and
a cable connected to the connector, the cable has an internal cable and a cable shield surrounding the internal cable, the casing accommodates an end of the cable, the ring-like member is positioned around the cable inside the casing, the ring-like member has a flat spring portion extending between the cable shield and the casing and contacting both the cable shield and the casing.

2. The cable connector assembly according to claim 1, wherein the flat spring portion has a first contacting portion contacting the cable shield and a second contacting portion contacting the casing.

3. The cable connector assembly according to claim 1, wherein the flat spring portion has a bend bent to form a peak toward the cable, the flat spring portion contacts the cable shield at the bend.

4. The cable connector assembly according to claim 1, wherein the flat spring portion has a bump protruding toward an inner side face of the casing at a distal end side of the flat spring portion, the flat spring portion contacts the casing at the bump.

5. The cable connector assembly according to claim 1, wherein the casing and the cable shield are electrically connected to each other via the flat spring portion of the ring-like member.

6. The cable connector assembly according to claim 1, wherein the ring-like member is positioned around an outer peripheral side of the cable shield.

7. The cable connector assembly according to claim 1, wherein the ring-like member has a base portion through which the cable extends, the base portion is located at the end of the cable accommodated in the casing.

8. The cable connector assembly according to claim 7, wherein the flat spring portion extends from the base portion toward another end of the cable.

9. The cable connector assembly according to claim 8, wherein the casing includes an abutted face extending along a radial direction of the cable inside the casing, the base portion includes an abutting face abutting the abutted face.

10. The cable connector assembly according to claim 8, wherein the base portion, as seen from an extension direction of the cable, has a contour including a corner of the base portion.

11. The cable connector assembly according to claim 8, wherein a contour shape of the base portion, as seen from an extension direction of the cable, is polygonal.

12. The cable connector assembly according to claim 8, wherein the casing has a ring-like member accommodation region accommodating the ring-like member positioned around the cable, the ring-like member accommodation region, as seen from an extension direction of the cable, has a shape complementary to a contour of the base portion.

13. The cable connector assembly according to claim 1, wherein the casing has an insertion port protruding in a tubular shape from a side face of the casing along a lead-out direction of the cable, the connector has a threaded member inserted into the casing through the insertion port and combined with an inner side face of the insertion port.

14. The cable connector assembly according to claim 13, wherein the ring-like member is movable into the casing as the threaded member is inserted into the insertion port.

15. The cable connector assembly according to claim 13, wherein the connector has an intermediate sealing member between the ring-like member and the threaded member.

16. The cable connector assembly according to claim 15, wherein the intermediate sealing member has a supporting portion extending between the casing and the cable toward the ring-like member.

17. The cable connector assembly according to claim 16, wherein the supporting portion is provided in a region where the flat spring portion is absent between the ring-like member and the intermediate sealing member.

18. The cable connector assembly according to claim 16, wherein the flat spring portion and the supporting portion are adjacent to each other in a peripheral direction of the cable.

19. The cable connector assembly according to claim 16, wherein the flat spring portion is one of a plurality of flat spring portions of the ring-like member and the supporting portion is one of a plurality of supporting portions of the intermediate sealing member.

20. The cable connector assembly according to claim 19, wherein the flat spring portions and the supporting portions are positioned alternately along an outer periphery of the cable.
